(19) United States
(12) Patent Application Publication
(10) Pub. No.: US 2017/0078570 A1
(43) Pub. Date: Mar. 16, 2017

(54) IMAGE PROCESSING DEVICE, IMAGE PROCESSING METHOD, AND IMAGE PROCESSING PROGRAM

(71) Applicant: TOPCON CORPORATION, Itabashi-ku (JP)

(72) Inventors: Tadayuki ITO, Itabashi-ku (JP); You Sasaki, Itabashi-ku (JP); Takahiro Komeichi, Itabashi-ku (JP); Naoki Morikawa, Itabashi-ku (JP)

(73) Assignee: TOPCON CORPORATION, Itabashi-ku (JP)

(21) Appl. No.: 15/264,950

(22) Filed: Sep. 14, 2016

(30) Foreign Application Priority Data
Sep. 15, 2015 (JP) 2015-181893

(51) Int. Cl. H04N 5/232; G06T 7/20; G06T 7/60; G06F 3/0354; H04N 5/265; G06T 7/00

(52) U.S. Cl. CPC H04N 5/23238; H04N 5/265; G06T 7/004; G06T 7/60; G06F 3/03543; G06T 7/20

(57) ABSTRACT

Deviations in a panoramic image obtained by compositing multiple images are corrected. An image processing device includes an image data receiving unit, a selection receiving unit, a three-dimensional position obtaining unit, a projection sphere setting unit, and a composited image generating unit. The image data receiving unit receives data of multiple still images, which are taken from different viewpoints and contain the same object. The selection receiving unit receives selection of a specific position of the object. The three-dimensional position obtaining unit obtains data of a three-dimensional position of the selected position. The projection sphere setting unit calculates a radius “R” based on the three-dimensional position of the selected position and sets a projection sphere having the radius “R”. The composited image generating unit projects the multiple still images on the projection sphere and thereby generates a composited image.

### BACKGROUND OF THE INVENTION

Technical Field

The present invention relates to a technique for obtaining a wide-angle image by compositing multiple images.

Background Art

A wide-angle image, which is a so-called “panoramic image”, can be obtained by compositing (stitching together) multiple still images taken in different viewing directions. Such techniques are publicly known and an example is disclosed in Japanese Unexamined Patent Application Laid-Open No. 2014-155168. This technique is used in cameras, and for example, panoramic cameras and cameras for photographing the entire celestial sphere are publicly known.

A panoramic image may be generated by setting a projection sphere that has a center at a specific viewpoint and by projecting multiple images on the inner circumferential surface of the projection sphere. At that time, the multiple images are composited so that adjacent images partially overlap, whereby the panoramic image is obtained. If the multiple images for compositing the panoramic image have the same viewpoints, no discontinuity is generated between multiple images, and no distortion is generated in the panoramic image, in principle. However, the multiple images to be composited can have viewpoints that are different from each other. For example, in a panoramic camera equipped with multiple cameras, the positions of the viewpoints of the multiple cameras cannot be physically made to coincide. Consequently, a panoramic image can contain discontinuities at stitched portions of the multiple images and be distorted overall.

### SUMMARY OF THE INVENTION

In view of these circumstances, an object of the present invention is to solve deviations in a panoramic image that is obtained by compositing multiple images.

A first aspect of the present invention provides an image processing device including an image data receiving unit, a selection receiving unit, a three-dimensional position obtaining unit, a projection sphere setting unit, and a composited image generating unit. The image data receiving unit is configured to receive data of a first still image and a second still image, which are taken from different viewpoints and contain the same object. The selection receiving unit is configured to receive selection of a specific position of the object. The three-dimensional position obtaining unit is configured to obtain data of a three-dimensional position of the selected position. The projection sphere setting unit is configured to calculate a radius “R” based on the three-dimensional position of the selected position and to set a projection sphere having the radius “R”. The composited image generating unit is configured to project the first still image and the second still image on the projection sphere and thereby generate a composited image.

According to a second aspect of the present invention, in the invention according to the first aspect of the present invention, the image processing device may further include a distance calculating unit that is configured to calculate a distance “r” between a center position of the projection sphere and the selected position. In this case, the projection sphere setting unit may calculate the radius “R” based on the distance “r”.

According to a third aspect of the present invention, in the invention according to the second aspect of the present invention, the radius “R” may be made to coincide with the value of the distance “r”.

According to a fourth aspect of the present invention, in the invention according to any one of the first to the third aspects of the present invention, the composited image may be displayed on a display, the selection receiving unit may receive the selection of the specific position based on a position of a cursor on the displayed composited image, and the projection sphere setting unit may vary the radius “R” corresponding to the movement of the cursor.

A fifth aspect of the present invention provides an image processing method including receiving data of a first still image and a second still image, which are taken from different viewpoints and contain the same object, receiving selection of a specific position of the object, and obtaining data of a three-dimensional position of the selected position. The image processing method further includes calculating a radius “R” based on the three-dimensional position of the selected position so as to set a projection sphere having the radius “R”, projecting the first still image and the second still image on the projection sphere so as to generate a composited image, and transmitting data of the composited image to a display.

A sixth aspect of the present invention provides a computer program product including a non-transitory computer-readable medium storing computer-executable program codes for processing images. The computer-executable program codes include program code instructions for receiving data of a first still image and a second still image, which are taken from different viewpoints and contain the same object, receiving selection of a specific position of the object, and obtaining data of a three-dimensional position of the selected position. The computer-executable program codes further include program code instructions for calculating a radius “R” based on the three-dimensional position of the selected position so as to set a projection sphere having the radius “R”, projecting the first still image and the second still image on the projection sphere so as to generate a composited image, and transmitting data of the composited image to a display.

According to the present invention, deviations in a panoramic image that is obtained by compositing multiple images are corrected.

### BRIEF DESCRIPTION OF DRAWINGS

FIG. 1 shows a principle for generating a panoramic image by compositing multiple images.

FIG. 2 shows a principle for generating image deviations.

FIG. 3 shows a condition for avoiding image deviations.

FIG. 4 is a block diagram of an embodiment.

FIG. 5 is a flow chart showing an example of a processing procedure.

FIG. 6 shows an example of a panoramic image.

FIG. 7 shows an example of a panoramic image.

FIG. 8 shows an example of a panoramic image.

FIG. 9 shows an example of an image, in which a panoramic image and a point cloud image are superposed on each other.

FIG. 10 shows an example of a panoramic image.

FIG. 11 shows an example of a panoramic image.

### PREFERRED EMBODIMENTS OF THE INVENTION

### Outline

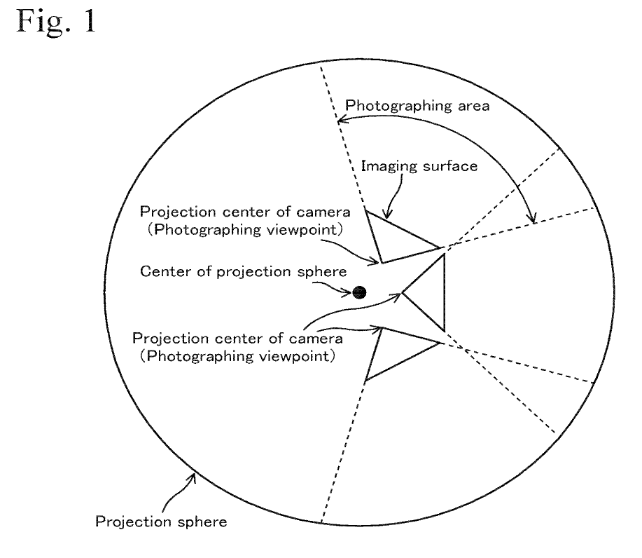

First, a technical problem will be described. The technical problem can occur in compositing multiple images that are taken from different viewpoints. FIG. 1 shows a situation in which three still images are respectively taken by three cameras from different positions (viewpoints) so as to partially overlap and are projected on an inner circumferential surface of a projection sphere for generating a panoramic image.

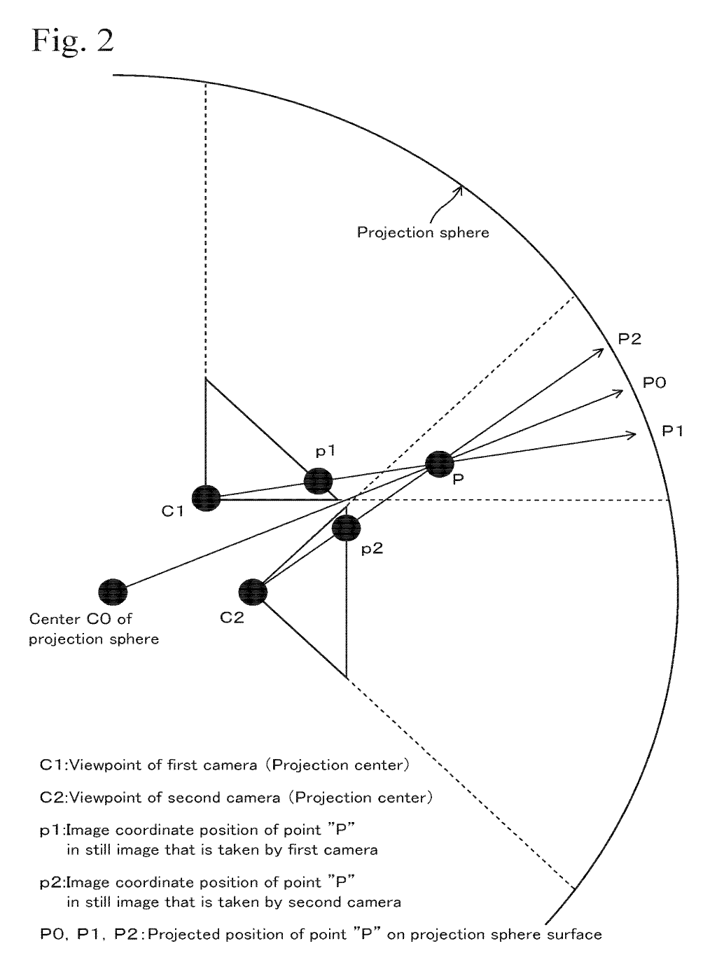

FIG. 2 shows a situation in which a first camera at a viewpoint C1 and a second camera at a viewpoint C2 photograph the position of a point “P”. Here, the viewpoint C1 does not coincide with the viewpoint C2, and the viewpoint C1 and the viewpoint C2 also do not coincide with a center C0 of a projection sphere for generating a panoramic image. In this case, the point “P” is positioned at a position p1 in the image that is taken by the first camera, and the point “P” is positioned at a position p2 in the image that is taken by the second camera.

First, a case of compositing images that are taken by two cameras is described. In this case, the positions p1 and p2 are projected on the surface of the projection sphere. Specifically, a directional line is set connecting the viewpoint C1 and the position p1, and a point at which the directional line intersects the projection sphere is a projected position P1 of the position p1 on the projection sphere. Similarly, a directional line is set connecting the viewpoint C2 and the position p2, and a point at which the directional line intersects the projection sphere is a projected position P2 of the position p2 on the projection sphere.

In this case, ideally, the image of the point “P” should be shown at a position P0 on the projection sphere for a generated panoramic image in the same way that the point “P” viewed from the center C0 is projected on the projection sphere. However, the point “P” is shown at the position P1 in the panoramic image based on the image taken by the first camera, whereas the point “P” is shown at the position P2 in the panoramic image based on the image taken by the second camera. Thus, the point “P” is shown at incorrect positions and looks blurry as two points in the panoramic image.

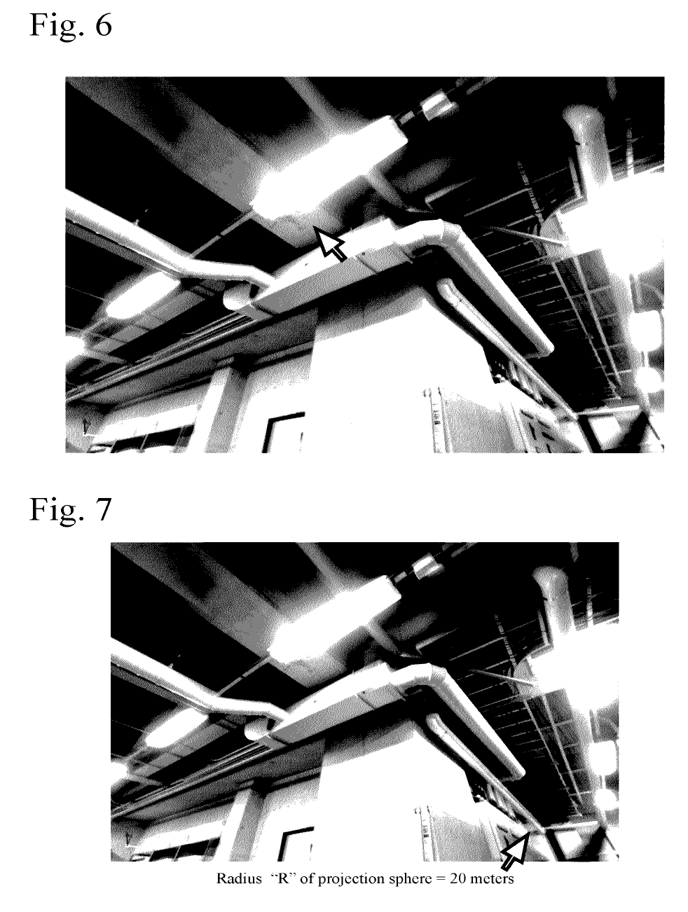

Due to this phenomenon, deviations are generated in a panoramic image. Moreover, distortions occur in the entirety of the panoramic image due to the difference in the viewpoint. FIG. 6 shows an example of a panoramic image in which this phenomenon occurs. The image shown in FIG. 6 contains deviations at a part of a fluorescent light at a slightly upper left from the center, which is shown by the arrow. These deviations are caused by the phenomenon, which is described by using FIG. 2, such that the image that should be viewed at the position P0 is shown at the positions P1 and P2. This phenomenon occurs due to the noncoincidence of the positions of the viewpoints C1 and C2 with the center C0 of the projection sphere.

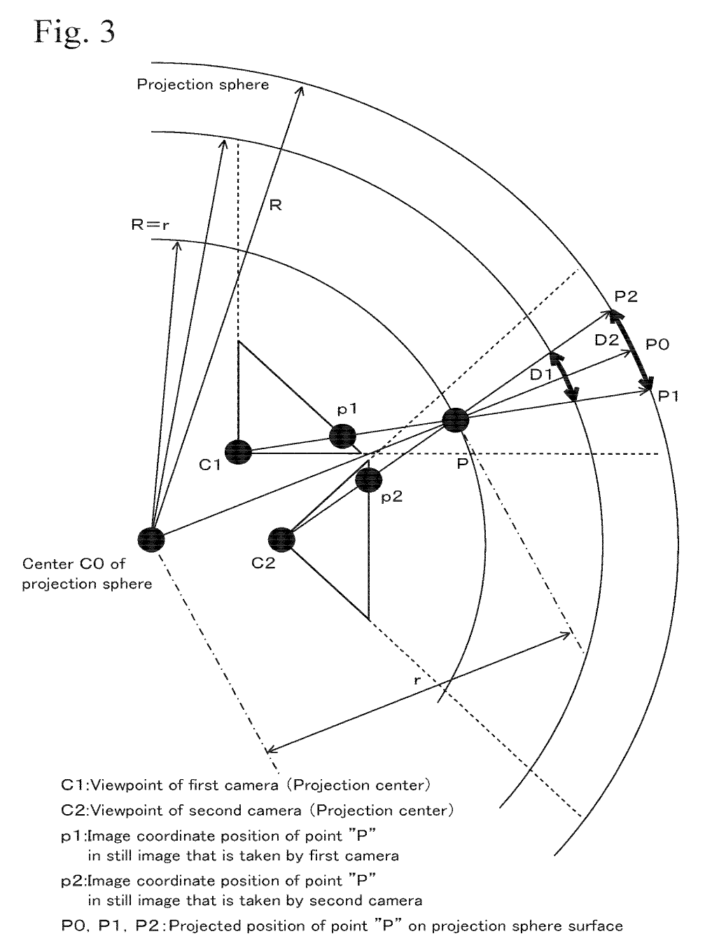

FIG. 3 is a conceptual diagram showing the principle of the present invention. FIG. 3 shows a situation in which the radius “R” of the projection sphere is made variable in the condition shown in FIG. 2. Here, each of the reference symbols D1 and D2 represents a difference between the projected position P1 and the projected position P2. The projected position P1 is obtained based on the image taken by the first camera. The projected position P2 is obtained based on the image taken by the second camera. As shown in FIG. 3, by varying the radius “R” of the projection sphere, a difference “D” between the projected positions varies accordingly.

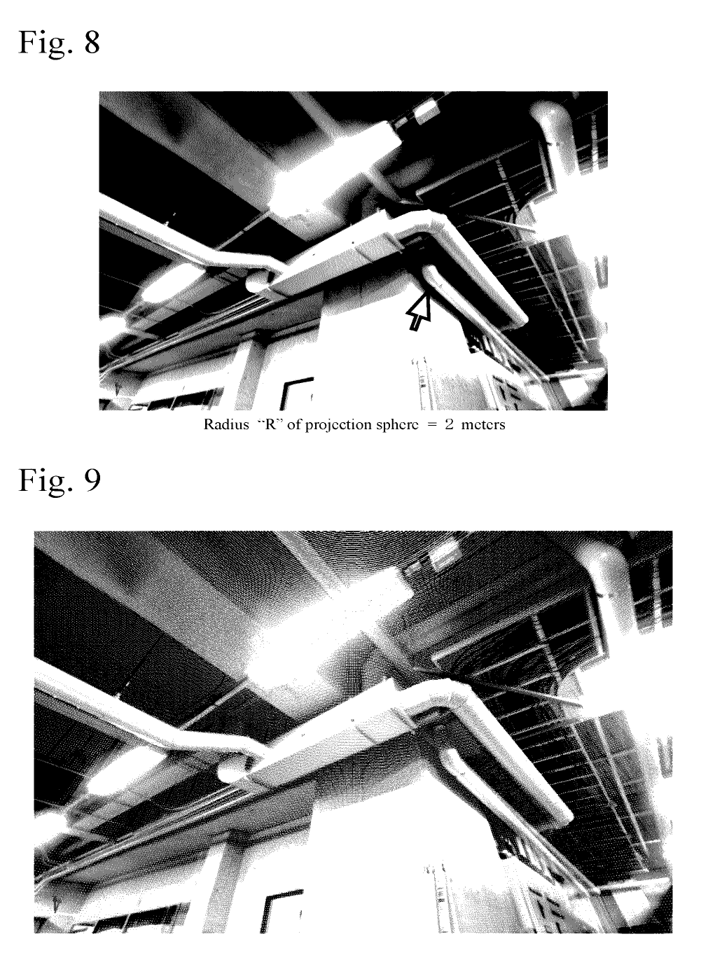

The variation in the difference “D” in accordance with the variation in the radius “R” can be viewed in a real image. FIGS. 7 and 8 show panoramic images that contain the same area. FIG. 7 is obtained by setting radius “R”=20 meters. FIG. 8 is obtained by setting radius “R”=2 meters. FIGS. 7 and 8 show a fluorescent light at an upper center part and a pipe extending in a lower right direction. The image of this fluorescent light is blurred, whereas the image of the pipe is not blurred and is clear in FIG. 7. On the other hand, the image of this fluorescent light is not blurred and is clear, whereas the image of this pipe is blurred in FIG. 8. The reason for these differences is that the positions of the fluorescent light and the pipe are different from each other and have a different value for the distance “r”, which corresponds to the point “P” in FIG. 3. Consequently, the difference “D” for the fluorescent light differs from that for the pipe because the difference “D” depends on the radius “R”.

As shown in FIG. 3, by making the radius “R” of the projection sphere coincide with the distance “r” between the center C0 of the projection sphere and the point “P”, that is, by setting radius “R”=distance “r”, the difference “D” is made zero. In this case, the positions of the points P1, P2, and P0 coincide with each other, and deviations in the panoramic image are corrected. To set radius “R”=distance “r”, the distance “r” must be calculated.

In this embodiment, the distance “r” is calculated from three-dimensional point cloud position data that is obtained by a laser distance measuring device (laser scanner) or the like. The procedure for calculating the distance “r” is described below. First, a point “P” is selected. Then, data of three-dimensional coordinates of the point “P” is obtained from three-dimensional point cloud data containing the point “P”. Next, the distance “r” is calculated based on position data of the center C0 of the projection sphere and the three-dimensional position data of the point “P”. Thereafter, the radius “R” is set so that radius “R”=distance “r”, and multiple images relating to the point “P” are composited on a projection sphere. According to such processing, deviations occurring at the position of the point “P” are corrected.

### Structure of Hardware

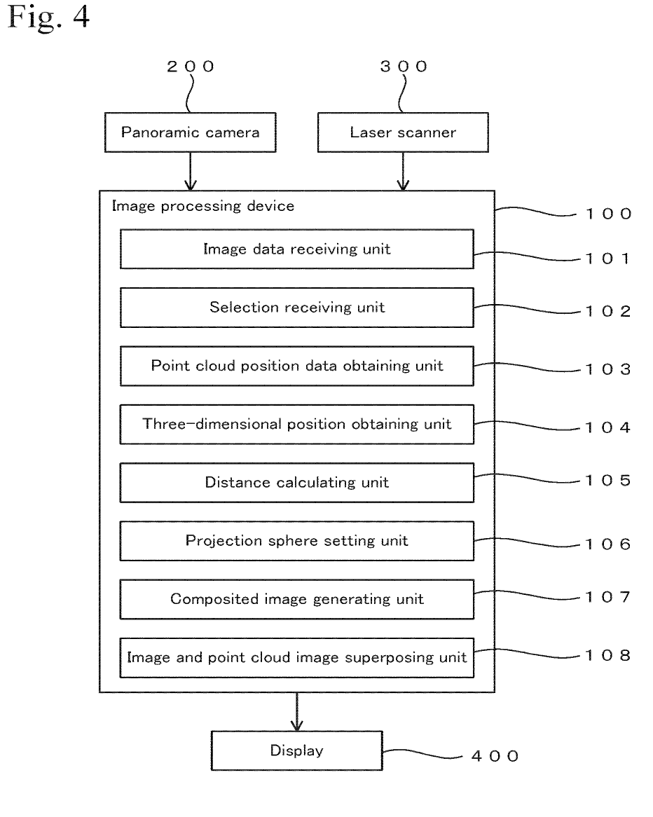

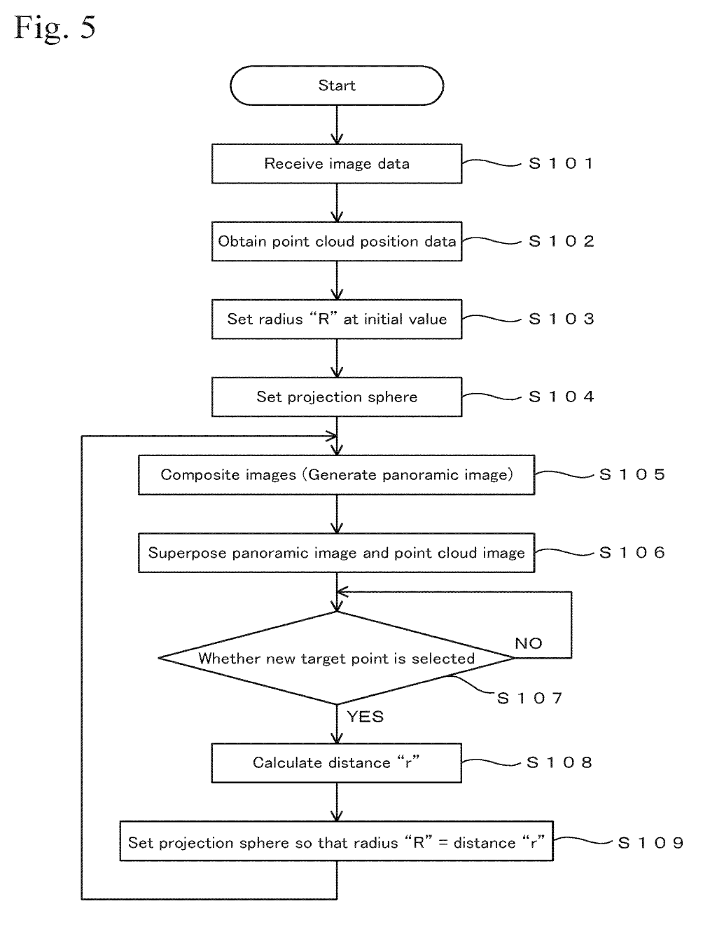

FIG. 4 shows a block diagram of an embodiment. FIG. 4 shows an image processing device 100, a panoramic camera 200, a laser scanner 300, and a display 400. The image processing device 100 functions as a computer and has functional units described below. The panoramic camera 200 is a multi-eye camera for photographing every direction and can photograph an overhead direction and the entirety of the surroundings over 360 degrees. In this embodiment, the panoramic camera 200 is equipped with six cameras. Five of the six cameras are directed in a horizontal direction and are arranged at positions at an equal angle (every 72 degrees) when viewed from a vertical direction. The rest is directed in the vertical upward direction at elevation angle of 90 degrees. The six cameras are arranged so that their view angles (photographing area) partially overlap. The still images that are obtained by the six cameras are composited, whereby a panoramic image is obtained.

The relative positional relationships and the relative directional relationships between the six cameras of the panoramic camera 200 are preliminarily examined and are therefore already known. Additionally, the positions of the viewpoints (projection centers) of the six cameras do not coincide with each other due to physical limitation. Details of a panoramic camera are disclosed in Japanese Unexamined Patent Applications Laid-Open Nos. 2012-204982 and 2014-071860, for example. A commercially available panoramic camera may be used as the panoramic camera 200. The commercially available panoramic camera may include a camera named “Ladybug3”, produced by Point Grey Research, Inc. Alternatively, a camera that is equipped with a rotary structure may be used for taking multiple still images in different photographing directions instead of the panoramic camera, and these multiple still images may be composited so that a panoramic image is obtained. Naturally, the panoramic image is not limited to an entire circumferential image and may be an image that contains the surroundings in a specific angle range. The data of the multiple still images, which are taken from different directions by the panoramic camera 200, is transmitted to the image processing device 100.

The six cameras photograph still images at the same time at specific timing. The photographing of each of the six cameras may be performed at a specific time interval. For example, the six cameras may be sequentially operated at a specific time interval for taking images, and the obtained images are composited so that an entire circumferential image is generated. Alternatively, a moving image may be taken. In the case of taking a moving image, frame images constituting the moving image, for example, frame images that are taken at a rate of 30 frames per second, are used as still images.

The laser scanner 300 emits laser light on an object and detects light that is reflected at the object, thereby measuring the direction and the distance from the laser scanner 300 to the object. At this time, three-dimensional coordinates of a point, at which the laser light is reflected, are calculated on the condition that exterior orientation parameters (position and attitude) of the laser scanner 300 are known. Even when the absolute position of the laser scanner 300 is unknown, three-dimensional point cloud position data in a relative coordinate system is obtained. The laser scanner 300 includes a laser emitting unit and a reflected light receiving unit. While moving the laser emitting unit and the reflected light receiving unit in vertical and horizontal directions such that a person nods his head, the laser scanner 300 performs laser scanning in the same area as the photographing area of the panoramic camera 200. Details of a laser scanner are disclosed in Japanese Unexamined Patent Applications Laid-Open Nos. 2008-268004 and 2010-151682, for example.

The positional relationship and the directional relationship between the laser scanner 300 and the panoramic camera 200 are preliminarily obtained and are already known. The coordinate system of point cloud position data that is obtained by the laser scanner 300 may be an absolute coordinate system or a relative coordinate system. The absolute coordinate system is a coordinate system that describes positions measured by using a GNSS or the like. The relative coordinate system is a coordinate system that describes a center of a device body of the panoramic camera 200 or another appropriate position as an origin.

In the case of using the absolute coordinate system, positional information of the panoramic camera 200 and the laser scanner 300 is obtained by a means such as a GNSS. In a condition in which the positional information of the panoramic camera 200 and the laser scanner 300 cannot be obtained, a relative coordinate system that has the position of the structural gravity center of the panoramic camera 200 or the like as an origin is set. Then, the positional relationship and the directional relationship between the laser scanner 300 and the panoramic camera 200, and three-dimensional point cloud position data that is obtained by the laser scanner 300, are described by the relative coordinate system.

The display 400 is an image display device such as a liquid crystal display. The display 400 may include a tablet or a display of a personal computer. The display 400 receives data of the images that are processed by the image processing device 100 and displays the images.

FIG. 4 shows each functional unit equipped on the image processing device 100. The image processing device 100 includes a CPU, various kinds of storage units such as an electronic memory and a hard disk drive, various kinds of arithmetic circuits, and interface circuits, and the image processing device 100 functions as a computer that executes functions described below.

The image processing device 100 includes an image data receiving unit 101, a selection receiving unit 102, a point cloud position data obtaining unit 103, a three-dimensional position obtaining unit 104, a distance calculating unit 105, a projection sphere setting unit 106, a composited image generating unit 107, and an image and point cloud image superposing unit 108. These functional units may be constructed of software, for example, may be constructed so that programs are executed by a CPU, or may be composed of dedicated arithmetic circuits. In addition, a functional unit that is constructed of software and a functional unit that is composed of a dedicated arithmetic circuit may be used together. For example, each of the functional units shown in FIG. 4 is composed of at least one electronic circuit of a CPU (Central Processing Unit), an ASIC (Application Specific Integrated Circuit), and a PLD (Programmable Logic Device) such as an FPGA (Field Programmable Gate Array).

Whether each of the functional units, which constitute the image processing device 100, is to be constructed of dedicated hardware or to be constructed of software so that programs are executed by a CPU is selected in consideration of necessary operating speed, cost, amount of electric power consumption, and the like. For example, if a specific functional unit is composed of an FPGA, the operating speed is superior, but the production cost is high. On the other hand, if a specific functional unit is configured so that programs are executed by a CPU, the production cost is reduced because hardware resources are conserved. However, when the functional unit is constructed using a CPU, the operating speed of this functional unit is inferior to that of dedicated hardware. Moreover, in this case, there may be cases in which complicated operation cannot be performed. Constructing the functional unit by dedicated hardware and constructing the functional unit by software differ from each other as described above, but are equivalent to each other from the viewpoint of obtaining a specific function.

Hereinafter, each of the functional units that are equipped on the image processing device 100 will be described. The image data receiving unit 101 receives data of the still images that are taken by the panoramic camera 200. Specifically, the image data receiving unit 101 receives data of the still images that are taken by the six cameras equipped on the panoramic camera 200.

The selection receiving unit 102 receives selection of a target point in a composited image (panoramic image) that is generated by the composited image generating unit 107. For example, two still images that contain the same object may be composited so that a panoramic image will be generated, and the panoramic image may be displayed on a display of a PC (Personal Computer). In this condition, a user may control a GUI (Graphical User Interface) of the PC and may select a point as a target point. The selected point is processed so as to decrease deviations in the image by using the present invention. Specifically, the user may move a cursor to a target point and may click a left button, thereby selecting the target point. The image position of the target point that is selected with the cursor is obtained by the function of the GUI.

The point cloud position data obtaining unit 103 takes point cloud position data in the image processing device 100 from the laser scanner 300. Although the point cloud position data is measured by the laser scanner 300 in this embodiment, the point cloud position data may instead be obtained from stereoscopic images. Details of a technique for obtaining point cloud position data by using stereoscopic images are disclosed in Japanese Unexamined Patent Application Laid-Open No. 2013-186816.

The three-dimensional position obtaining unit 104 obtains the three-dimensional position of the target point, which is selected by the selection receiving unit 102, based on the point cloud position data. Hereinafter, this processing will be described. The three-dimensional point cloud position of the target point is obtained by using a superposed image. The superposed image is obtained by superposing a panoramic image and the three-dimensional point cloud position data on each other by the image and point cloud image superposing unit 108, which is described later. First, the superposed image of the panoramic image and the three-dimensional point cloud position data will be described.

The direction of each point that constitutes the point clouds, as viewed from the laser scanner 300, is determined from the point cloud position data. Thus, by projecting each point as viewed from the laser scanner 300 on an inner circumferential surface of a projection sphere, a point cloud image that has the projected points as pixels, that is, a two-dimensional image composited of point clouds, is generated. The projection sphere is set by the projection sphere setting unit 106, which is described below. The point cloud image is composited of points and can be used in the same way as an ordinary still image.

The relative positional relationship and the relative directional relationship between the panoramic camera 200 and the laser scanner 300 are preliminarily obtained and are already known. Thus, the still images that are taken by the six cameras of the panoramic camera 200 and the point cloud image are superposed on each other in the same manner as the method of compositing the images of the six cameras, which constitutes the panoramic camera 200. According to this principle, the panoramic image, which is obtained by compositing the multiple still images that are taken by the panoramic camera 200, and the point cloud image are superposed on each other. The image thus obtained is a superposed image of the image and the point clouds. An example of an image that is obtained by superposing a panoramic image and a point cloud image on each other (superposed image of an image and point clouds) is shown in FIG. 9. The processing for generating the image as exemplified in FIG. 9 is performed by the image and point cloud image superposing unit 108.

The superposed image exemplified in FIG. 9 is used for obtaining the three-dimensional position of the target point, which is selected by the selection receiving unit 102, based on the point cloud position data. Specifically, a point of the point cloud position data, which corresponds to the image position of the target point that is selected by the selection receiving unit 102, is obtained from the superposed image exemplified in FIG. 9. Then, the three-dimensional coordinate position of this obtained point is obtained from the point cloud position data that is obtained by the point cloud position data obtaining unit 103. On the other hand, if there is no point that corresponds to the target point, the three-dimensional coordinates of the target point is obtained by using one of the following three methods. One method is selecting a point in the vicinity of the target point and obtaining the three-dimensional position thereof. Another method is selecting multiple points in the vicinity of the target point and obtaining an average value of the three-dimensional positions thereof. Another method is preselecting multiple points in the vicinity of the target point, finally selecting multiple points, of which three-dimensional positions are close to the target point, from the preselected multiple points, and obtaining an average value of the three-dimensional positions of the finally selected points. The above-described processing for obtaining the three-dimensional position of the target point by using the superposed image is performed by the three-dimensional position obtaining unit 104.

The distance calculating unit 105 calculates a distance between the three-dimensional position of the target point, which is obtained by the three-dimensional position obtaining unit 104, and the center of the projection sphere. The projection sphere is set by the projection sphere setting unit 106 and is used for generating a composited image (panoramic image) by the composited image generating unit 107. For example, the distance “r” in FIG. 3 is calculated by the distance calculating unit 105.

The center of the projection sphere is, for example, set at a position of the structural gravity center of the panoramic camera 200. Naturally, the center of the projection sphere may be set at another position. The relative exterior orientation parameters (position and attitude) of the laser scanner 300 and the six cameras of the panoramic camera 200 are preliminary obtained and are already known. Thus, the position of the center of the projection sphere and the three-dimensional position of the target point, which is obtained by the three-dimensional position obtaining unit 104, are described by using the same coordinate system. Therefore, the distance (for example, the distance “r” in FIG. 3) between the three-dimensional position of the target point, which is obtained by the three-dimensional position obtaining unit 104, and the center of the projection sphere, which is set by the projection sphere setting unit 106, is calculated.

The projection sphere setting unit 106 sets a projection sphere that is necessary for generating a panoramic image. Hereinafter, the function of the projection sphere setting unit 106 will be described with reference to FIG. 3. As shown in FIG. 3, the projection sphere is a virtual projection surface that has a structural gravity center of the panoramic camera 200 as its center and that has a spherical shape with a radius “R”. The six still images, which are respectively taken by the six cameras of the panoramic camera 200, are projected on the projection surface so as to be composited, thereby generating a panoramic image that is projected on the inside of the projection sphere. The center of the projection sphere is not limited to the position of the structural gravity center of the panoramic camera 200 and may be another position.

The essential function of the projection sphere setting unit 106 is to vary the radius “R” of the projection sphere described above. This function will be described below. First, before the selection receiving unit 102 receives selection of a specific position in the image on the display, the projection sphere setting unit 106 selects a predetermined initial set value for the radius “R” and sets a projection sphere. The initial set value of the radius “R” may be, for example, a value from several meters to several tens of meters, or it may be an infinite value.

After the selection receiving unit 102 receives selection of a specific position (target point) in the image on the display, the projection sphere setting unit 106 sets the radius “R” of the projection sphere in accordance with the distance “r” between the target point and the center of the projection sphere. In this embodiment, the processing is performed so that radius “R”=distance “r”. Although the radius “R” may not necessarily be made equal to the distance “r”, the radius “R” is preferably made close to the value of the distance “r” as much as possible. For example, the radius “R” is made to coincide with the value of the distance “r” at a precision of not greater than plus or minus 5%.

The distance calculating unit 105 calculates the distance “r” in real time. The projection sphere setting unit 106 also calculates the radius “R” in real time in accordance with the distance “r” that is calculated in real time. For example, when a user changes the position of the target point to be received by the selection receiving unit 102, the distance calculating unit 105 recalculates the distance “r”. Correspondingly, the projection sphere setting unit 106 also recalculates the radius “R” so that radius “R”=distance “r”.

The composited image generating unit 107 projects the still images, which are respectively photographed by the six cameras of the panoramic camera 200, on the inner circumferential surface of the projection sphere having the radius “R”, which is set by the projection sphere setting unit 106. Then, the composited image generating unit 107 generates a panoramic image that is made of the six still images, which are composited so as to partially overlap with each other.

In the above structure, as shown in FIG. 3, when a specific point is selected as the target point “P” in the panoramic image, the distance “r” is calculated, and the processing is performed so that radius “R”=distance “r”. As a result, the radius “R” of the projection sphere dynamically varies correspondingly to the variation in the distance “r” due to the positional change of the target point “P”.

### Example of Processing

Hereinafter, an example of a processing procedure that is executed by the image processing device 100 shown in FIG. 4 will be described. Programs for executing the processing, which are described below, are stored in a storage region in the image processing device 100 or an appropriate external storage medium and are executed by the image processing device 100.

After the processing is started, data of still images, which are taken by the panoramic camera 200, is received (step S101). Here, data of the still images respectively taken by the six cameras of the panoramic camera 200 is received. The image data may be fetched from data, of which images are taken in advance and are preliminarily stored in an appropriate storage region, instead of obtaining the image data from the panoramic camera 200 in real time. This processing is performed by the image data receiving unit 101 shown in FIG. 4. In addition, point cloud position data that is measured by the laser scanner 300 is obtained (step S102). This processing is performed by the point cloud position data obtaining unit 103.

Then, the radius “R” of a projection sphere is set at an initial value (step S103). A predetermined value is used as the initial value. After the radius “R” is set at the initial value, the projection sphere is set (step S104). The processing in steps S103 and S104 is performed by the projection sphere setting unit 106 shown in FIG. 4.

After the projection sphere is set, the still images are projected on the inner circumferential surface of the projection sphere that is set in step S104, based on the image data that is received in step S101, and the still images are composited (step S105). The still images are taken by the six cameras equipped on the panoramic camera 200. The processing in step S105 is performed by the composited image generating unit 107 shown in FIG. 4. The processing in step S105 provides a panoramic image in which the surroundings are viewed from the center of the projection sphere. The data of the panoramic image that is obtained by the processing in step S105 is output from the composited image generating unit 107 to the display 400 in FIG. 4, and the panoramic image is displayed on the display 400.

After the panoramic image is obtained, the panoramic image and a point cloud image are superposed on each other (step S106). This processing is performed by the image and point cloud image superposing unit 108. An example of a displayed superposed image that is thus obtained is shown in FIG. 9.

After the panoramic image and the superposed image of the panoramic image and the point clouds are obtained, whether selection of a new target point (the point “P” in the case shown in FIG. 3) is received by the selection receiving unit 102 is judged (step S107). If a new target point is selected, the processing advances to step S108. Otherwise, the processing in step S107 is repeated. For example, when the target point is not changed, the radius “R” that is set at this time is maintained.

When the target point is changed, the distance “r” (refer to FIG. 3) is calculated by the distance calculating unit 105 in FIG. 4 (step S108). The distance “r” is calculated as follows. First, the position of the target point in the panoramic image is identified. Next, the position of the target point is identified in the superposed image of the panoramic image and the point cloud image, which is obtained in the processing in step S106 (for example, the image shown in FIG. 9). Thus, three-dimensional coordinates at a position (for example, the point “P” in FIG. 3) corresponding to the target point are obtained. Then, a distance between the three-dimensional position of the target point and the position of the center of the projection sphere is calculated. For example, in the case shown in FIG. 3, the distance “r” between the point “P” and the center C0 is calculated.

After the distance “r” is calculated, the projection sphere is updated by setting radius “R”=distance “r” (step S109). After the radius “R” is recalculated, the processing in step S105 and the subsequent steps is executed again by using the recalculated value of the radius “R”. Consequently, the radius “R” (refer to FIG. 3) for the panoramic image to be displayed on the display 400 varies so that radius “R”=distance “r”, and a panoramic image, in which the varied value of the radius “R” is reflected, is displayed.

Thus, when the distance “r” varies due to the change of the target point, the radius “R” varies accordingly. That is, when the target point is changed, and the three-dimensional position of the target point is therefore changed, the radius of the projection sphere having the projection surface for the panoramic image varies dynamically. Thereafter, a panoramic image that is changed correspondingly to the change in the projection sphere is displayed.

### Advantages

According to the principle shown in FIG. 3, the distance “r” is calculated when a target point “P” is selected, and the radius “R” is set so that radius “R”=distance “r”. Consequently, deviation of the projected image at the position of the point “P” is corrected. When the position of the target point “P” is changed, and the distance “r” therefore varies, the radius “R” also varies correspondingly so that radius “R”=distance “r”. Accordingly, high precision of the image at the target point “P” is maintained.

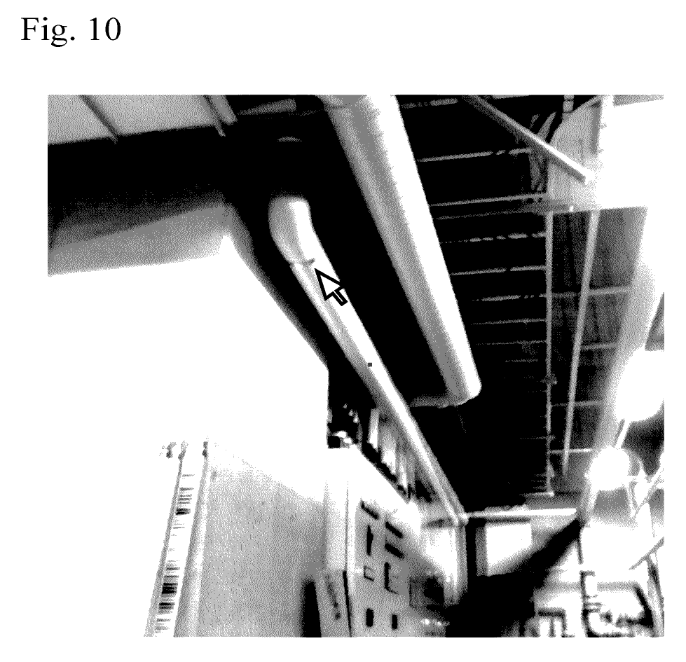

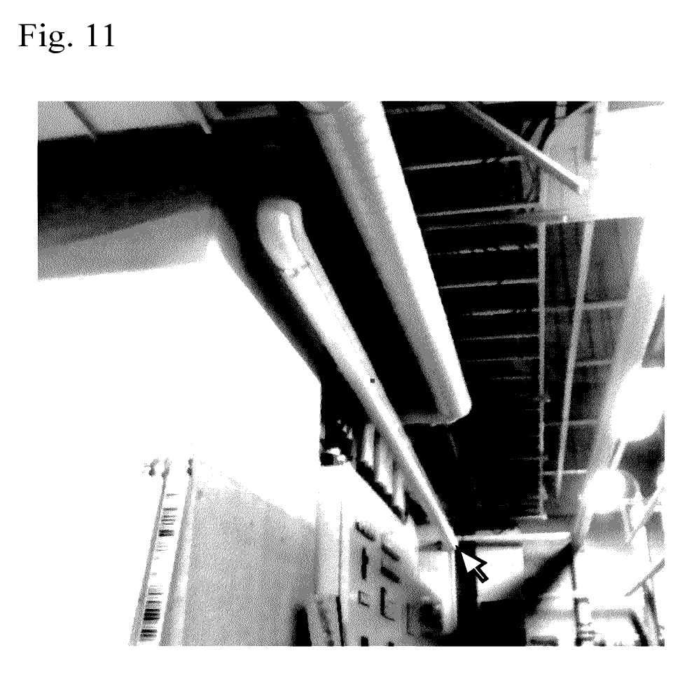

Each of FIGS. 10 and 11 shows an example of a situation in which a target point is selected with a cursor in the image. In each of these cases, the portion indicated with the cursor is the target point, and the processing is performed so that radius “R”=distance “r”. As a result, the image at the target point selected with the cursor is clearly described. Meanwhile, the image in which the radius “R” deviates from the value of the distance “r” is blurred. As the deviated amount increases, the degree of blurriness increases. For example, the position of the clearly described image is changed in accordance with the movement of the cursor.

### Other Matters

The selection of the target point may be received by another method. That is, the panoramic image that is generated by the composited image generating unit 107 is displayed on a touch panel display, and this display may be touched using a stylus or the like, whereby the selection of the target point is received.

In yet another method, the direction of gaze of a user viewing the panoramic image, which is generated by the composited image generating unit 107, is detected, and an intersection point of the direction of gaze and the image plane of the panoramic image is calculated. Then, the position of the intersection point is received as a selected position. This method allows dynamic adjustment of the radius of the projection sphere for clearly describing the image at the position at which the user gazes. Details of a technique for detecting a direction of gaze are disclosed in Japanese Unexamined Patent Application Laid-Open No. 2015-118579, for example.

What is claimed is:

1. An image processing device comprising:
an image data receiving unit configured to receive data of a first still image and a second still image, which are taken from different viewpoints and contain the same object;
a selection receiving unit configured to receive selection of a specific position of the object;
a three-dimensional position obtaining unit configured to obtain data of a three-dimensional position of the selected position;
a projection sphere setting unit configured to calculate a radius “R” based on the three-dimensional position of the selected position and to set a projection sphere having the radius “R”; and
a composited image generating unit configured to project the first still image and the second still image on the projection sphere and thereby generate a composited image.

2. The image processing device according to claim 1, wherein the image processing device further comprises a distance calculating unit that is configured to calculate a distance “r” between a center position of the projection sphere and the selected position, and the projection sphere setting unit calculates the radius “R” based on the distance “r”.

3. The image processing device according to claim 2, wherein the radius “R” is made to coincide with the value of the distance “r”.

4. The image processing device according to claim 1, wherein the composited image is displayed on a display, the selection receiving unit receives the selection of the specific position based on a position of a cursor on the displayed composited image, and the projection sphere setting unit varies the radius “R” corresponding to the movement of the cursor.

5. An image processing method comprising:
receiving data of a first still image and a second still image, which are taken from different viewpoints and contain the same object;
receiving selection of a specific position of the object;
obtaining data of a three-dimensional position of the selected position;
calculating a radius “R” based on the three-dimensional position of the selected position so as to set a projection sphere having the radius “R”;
projecting the first still image and the second still image on the projection sphere so as to generate a composited image; and
transmitting data of the composited image to a display.

6. A computer program product comprising a non-transitory computer-readable medium storing computer-executable program codes for processing images, the computer-executable program codes comprising program code instructions for:
receiving data of a first still image and a second still image, which are taken from different viewpoints and contain the same object;
receiving selection of a specific position of the object;
obtaining data of a three-dimensional position of the selected position;
calculating a radius “R” based on the three-dimensional position of the selected position so as to set a projection sphere having the radius “R”;
projecting the first still image and the second still image on the projection sphere so as to generate a composited image; and
transmitting data of the composited image to a display.

7. The image processing device according to claim 2, wherein the composited image is displayed on a display, the selection receiving unit receives the selection of the specific position based on a position of a cursor on the displayed composited image, and the projection sphere setting unit varies the radius “R” corresponding to the movement of the cursor.

8. The image processing device according to claim 3, wherein the composited image is displayed on a display, the selection receiving unit receives the selection of the specific position based on a position of a cursor on the displayed composited image, and the projection sphere setting unit varies the radius “R” corresponding to the movement of the cursor.
